(19) United States
(12) Patent Application Publication
(10) Pub. No.: US 2018/0027762 A1
(43) Pub. Date: Feb. 1, 2018

(54) HYBRID HEAT RECOVERY SYSTEM WITH ENERGY RECOVERY AND USE THEREOF

(71) Applicant: Mathieu Brodeur, Saint-Alphonse-de-Granby (CA)

(72) Inventor: Mathieu Brodeur, Saint-Alphonse-de-Granby (CA)

(21) Appl. No.: 15/660,713

(22) Filed: Jul. 26, 2017

Related U.S. Application Data
(60) Provisional application No. 62/366,657, filed on Jul. 26, 2016.

(51) Int. Cl. A01K 1/00; A01K 31/22

(52) U.S. Cl. CPC A01K 1/0076; A01K 1/0064; A01K 31/22

(57) ABSTRACT

A ventilation apparatus for ventilating a building. The ventilation apparatus comprises a casing comprising: a cavity for housing a removable heat-exchange cartridge; a service door providing access to the cavity; a primary and secondary pathways fluidly connecting the inside of the building to the outside of the building, wherein the primary pathway and the secondary pathway cross the cavity along about perpendicular axes; a primary ventilator for forcing an airflow in the building through the primary pathway; and a controllable secondary ventilator for forcing a controllable airflow through the secondary pathway. The ventilation apparatus, when the casing houses the heat-exchange cartridge, has the primary ventilator forcing an inflow of air through the primary pathway, and (ii) the controllable second ventilator for controllably forcing either an outflow or an inflow of air through the secondary pathway. The ventilation apparatus, without heat-exchange cartridge, has only inflow(s) forced through the pathway(s).

### CROSS-REFERENCE TO RELATED APPLICATIONS

This application claims priority on U.S. Provisional Patent Application No. 62/366,657 filed on Jul. 26, 2016, which is herein incorporated by reference in its entirety.

### FIELD

The present subject-matter relates to poultry barns and, more particularly, to controlling the temperature therein.

### BACKGROUND

In modern poultry production, chicks are reared in specially conceived brooder barns where 10 000 to 50 000 birds are brooded in the same enclosed environment. In addition to feeding and watering, the commercial poultry barns must provide and control adequate temperature, moisture and ventilation. Since baby chicks are endothermic animals, the grower must ensure a relatively high brooding temperature for the first three weeks of their lifetime. The poultry barn must imperatively maintain an ambient temperature of around 90° F. and provide sufficient fresh air for the first days of the chicks' lives. A failure to sustain the required temperature is detrimental to the chick's physiological development and may even cause illness and increase flock mortality.

The type of heating systems used to maintain room temperature varies depending on the type of fossil fuels or biomass available around the facility. In cold climates, the most common source of heat generated from the brooders is the direct combustion of propane or natural gas. Direct combustion of these gases within the poultry barn results in the production of carbon dioxide and water vapour. Therefore, a failure to provide adequate air renewal impairs the chick development as oxygen levels fall and combustion gases, hygrometry and ammonia rise. In addition, humid litter stimulates the growth of many pathogens, which may deteriorate the chicken's health and in turn increase the need for antibiotics. Flock mortality also increases as pathogens multiply humid litter.

For the above reasons, almost all commercial poultry barns are designed with a ventilation system where fresh air enters via spacious air inlets and dusty foul air is exhausted through many ventilators of various sizes, depending on the external temperature and the age of the poultry flock. As fresh air enters, it cools down the barn and stimulates the temperature sensors that in turn activate the brooders to burn more gas to maintain high temperatures. This cycle goes on and on throughout the growing cycle of the poultry flock. Poultry house heating during the brooding period represents a major expense for any chicken grower in temperate and cold climates. As the flock ages to maturity and feathers replace down, ambient barn temperature must gradually decrease to 65° F. In other words, heating costs decrease as poultry grow to market weight. Moreover, it has been observed that the amount of dust, down, debris and other air contaminants increase as the flock reaches market weight. Therefore, barn air contamination, particularly with respect to down, is inversely proportional to the amount of heat required to maintain the comfort level of poultry.

The use of air to air heat recovery apparatuses have been proven efficient in the last thirty years to recover the heat energy expelled from the exhaust ventilators and to use this energy to preheat the fresh air entering the poultry barns (see, for example, U.S. Pat. No. 4,512,392). As the fresh air enters and warms up in the heat-exchanger, it increases its capacity to absorb water and thus decreases the relative air humidity in the barn. Moreover, as the fresh air gains heat energy in the heat-exchanger, it considerably reduces heating costs for the chicken grower. Nowadays there are many different heat-exchangers designed for poultry houses and they vary in sizes, air flow capacities, materials and types of heat-exchanger cartridges ranging from a plurality of corrugated polypropylene sheets spaced by parallel extruding plastic strips or a plurality of tubular cells each formed from a single folded sheet of aluminum or even polypropylene tubes (see U.S. Pat. No. 4,512,392, U.S. Pat. No. 4,512,393 and U.S. Pat. No. 4,590,990).

Smaller heat-exchangers have the advantage of being strategically placed in the barn to ensure adequate air distribution as opposed to larger and more expensive self-cleaning units that require ducts of long and large diameters to carry and distribute fresh air from the heat-exchange unit to the barn. There are indications in scientific literature that larger surface areas for heat-exchangers provide better overall efficiency. The smaller the space between each sheet of a plurality of corrugated polypropylene sheets, where the dusty warm humid air flows through the heat-exchanger cartridge, the more efficient is the heat-exchange capacity. Moreover, corrugated polypropylene sheets with small sized flutes, where the cold fresh air flows through the heat-exchange cartridge, increase the surface area of the heat-exchanger and thus increase the heat transfer efficiency, but only as long as the heat-exchanger remains clean. As poultry ages to maturity in a commercial barn, the ambient air fills up with dust and down. Therefore, this dusty environment creates a real challenge for small compact heat-exchangers. As dust enters and fouls the heat-exchanger, the latter substantially loses efficiency. Fouling is the major constraint to the use of heat-exchangers in poultry barns. The task of cleaning heat-exchangers may be difficult and time consuming for poultry growers.

Known systems demonstrate the use of filters in preventing dust fouling in heat-exchangers. However, filters may fill up rapidly as the flock ages and the ventilators of the heat-exchanger apparatuses substantially lose efficiency. In such cases, filters must be changed or cleaned, either manually or mechanically, several times per day in order for the heat-exchanger to recover heat at its full potential. In small compact heat-exchangers, where dozens of units must be installed at strategic places in a barn, the time of filter maintenance is therefore multiplied. It has been demonstrated that the heat-exchanger ventilator can inverse its rotation to blow cold air across the fouled filter and return the dust back to the barn's environment periodically, which results in a partial filter cleaning (European Patent No. 2730850). However, blowing dusty air back to the barn's environment may increase bird respiratory health concerns. Moreover, in cold climates, this procedure may result in undesired high velocity cold drafts back to the chicks, which creates discomfort, stress and a potential for certain poultry illnesses.

Therefore, there is a need to revise the usage of heat-exchangers in commercial poultry houses to address heat recovery efficiency in correlation with dust fouling solutions.

There is therefore a need for a ventilation apparatus able to perform heat-exchange between the incoming air flow and the exhausted air flow, while requiring low maintenance of the heat-exchange cartridges without significantly compromising heating cost savings and adequate barn hygrometry. In other words, there is a need for a ventilation apparatus that may limit cleaning compared to heat-exchanger using full-time filters and heat-exchange cartridges, which may be advantageous when heat recovery from inside air to outside air is low or insignificant. Also, there is a need for a ventilation apparatus that may be used even in the summertime (warm periods) when exterior temperatures are higher than the desired barn temperatures and cooling the barns is a necessity as opposed to heat energy recovery.

### SUMMARY

It would thus be desirable to provide a novel apparatus for ventilating poultry barns.

This disclosure relates to a ventilation apparatus to provide ventilation to a building, said ventilation apparatus comprising: a removable heat-exchange cartridge, a casing adapted to receive said heat-exchange cartridge, a service door providing access to the interior of said casing, with an opening large enough to allow removal of said removable heat-exchange cartridge, a primary air inlet leading from the interior of the building, at least one primary air outlet leading to the exterior of building, at least one secondary air inlet/outlet leading to/from the exterior of the building, an air conduit leading to the interior of building, a primary ventilator which pulls air from the primary air inlet through said casing (whereas, when said heat-exchange cartridge is present, said primary ventilator pushes air through said heat-exchange cartridge in a primary pathway, leading air to exit from said at least one primary air outlet), and a secondary ventilator, located in said air conduit, connected to the interior of said casing, having a primary mode corresponding to a main rotation direction of said secondary ventilator to pull air from said at least one secondary air inlet/outlet through a heat-exchanging cartridge, when present, in a secondary pathway, leading air to exit through the air conduit, a secondary mode corresponding to a reversed rotation direction of said secondary ventilator, to push air from the air conduit through the interior of said casing, and a tertiary mode, whereas the second ventilator is stopped; whereas, when the heat-exchange cartridge is removed, air exits through one or both of said at least one primary air outlet and said at least one secondary air inlet/outlet.

According to an embodiment, there is disclosed a ventilation apparatus to be mounted to a structure of a building to provide ventilation to the building, the ventilation apparatus comprising: a casing comprising: a cavity adapted to house a removable heat-exchange cartridge; a service door providing access to the cavity; a primary air inlet fluidly connecting the cavity to the interior of the building; a primary air outlet fluidly connecting the cavity to the exterior of building, wherein a primary pathway fluidly connects the primary air inlet to the primary air outlet; a secondary air outlet/inlet, distinct from the primary air outlet, fluidly connecting the cavity to the exterior of the building, an air conduit, distinct from the primary air inlet, fluidly connecting the cavity to the interior of the building, wherein a secondary pathway fluidly connects the secondary air inlet/outlet to the air conduit; a primary ventilator for forcing an airflow through the primary pathway; and a secondary ventilator for forcing an airflow through the secondary pathway; wherein, when the casing houses the heat-exchange cartridge, (i) the primary ventilator forces an inflow of air in the building through the primary pathway, and (ii) the second ventilator when operating in a primary mode forces an outflow of air from the building through the secondary pathway, and when operating in a secondary mode forces inflow of air in the building through the secondary pathway; and wherein, when the casing houses no heat-exchange cartridge, only an inflow of air in the building is forced through the ventilation apparatus.

According to an aspect, the heat-exchange cartridge comprises a plurality of polypropylene sheets spaced by ethylene acetate strips; and/or the primary pathway passes through the heat-exchange cartridge about a substantially vertical axis.

According to an aspect, the primary pathway and the secondary pathway pass through the heat-exchange cartridge about substantially perpendicular axes; and optionally the heat-exchange cartridge provides segregated airflows of the primary pathway and of the secondary pathway.

According to an aspect, the heat-exchange cartridge comprises pathway sections completing the primary pathway and the secondary pathway when housed in the cavity.

According to an aspect, the second ventilator is a rotational ventilator can operate in a first rotational direction thereby generating the outflow and can operate a second rotational direction thereby generating the inflow.

According to an aspect, the secondary ventilator operates in a tertiary mode in which the secondary ventilator generates no airflow.

According to an aspect, the primary ventilator has a primary maximum rotation speed and the secondary ventilator as a second maximum rotation speed, and wherein the primary maximum rotation speed is different from the secondary maximum rotation speed; and optionally the ventilation apparatus has a rotation speed ratio defined by the primary maximum rotation speed over the secondary maximum rotation speed of about 2 or above.

According to an aspect, the ventilation apparatus further comprising shutters operatively connected to the secondary pathway, wherein the shutters are for closing the secondary pathway and thereby preventing back-drafts and optionally the shutters are removably mounted to one of the secondary air inlet/outlet and the air conduit and/or the shutter is operatively connected to the secondary pathway for preventing back-drafts; and/or the shutter is operatively connected to the primary air inlet for preventing air entering in the casing through the primary air inlet; and/or the shutter is detachable from the ventilation apparatus.

According to an aspect, the air conduit is mounted to the service door.

According to an aspect, the service door comprises mounting components on its interior side, and wherein the mounting components are used to secure a detachable shutter to the service door; and/or the mounting components comprises a frame defining a hollow rectangular shape.

According to an aspect, the casing comprises an opening connecting the exterior of the ventilation apparatus to the cavity, wherein the opening provides a passage to insert and/or remove the removable heat-exchange cartridge from the cavity; and/or the service door is for substantially closing the opening.

According to an aspect, the ventilation apparatus further comprises a temperature sensor fluidly monitoring temperature of airflow in the primary pathway; and/or the temperature sensor in mounted to the air conduit; and/or the ventilation apparatus comprises a speed controller operatively connected to one of the primary ventilator and the secondary ventilator, wherein the speed controller controls rotation speed of the operatively connected one of the primary ventilator and the secondary ventilator; and/or the speed controller establishes a rotation speed for the operatively connected one of the primary ventilator and the secondary ventilator based on temperature monitored by the temperature sensor.

According to an aspect, the ventilation apparatus further comprises a sprinkler nozzle fluidly connected to a water manifold, wherein the sprinkler nozzle is located substantially over the heat-exchange cartridge; and/or a computer comprising a computer program and operatively connected to the manifold, wherein the computer controls the manifold position to be open or closed based on the computer program; and/or a drain located below the casing, wherein the drain is for draining water sprayed by the sprinkler nozzle; and/or a spout mounted to air conduit; and/or the spout being removably mounted to the air conduit.

According to an aspect, the ventilation apparatus comprises a plurality of walls defining the casing, the ventilation apparatus further comprising an insulation layer, and wherein the insulation layer covers at least one of the panels.

According to an aspect, a wild bird proof grating, wherein the wild bird proof grating covers one of one of the air outlets and the secondary air inlet/outlet; and/or the grating is selected among a group comprising metal grids, plastic grids and flexible screen.

According to an aspect, the ventilation apparatus is to be installed in a poultry barn.

According to an embodiment, a ventilation apparatus to be mounted to a structure of a building to provide ventilation to the building, the ventilation apparatus comprising: a casing comprising: a cavity adapted to house a removable heat-exchange cartridge; a service door providing access to the cavity; a primary pathway fluidly connecting the inside of the building to the outside of the building; a secondary pathway fluidly connecting the inside of the building to the outside of the building, wherein the primary pathway and the secondary pathway cross the cavity along about perpendicular axes; a primary ventilator for forcing an airflow of air in the building through the primary pathway; and a controllable secondary ventilator for forcing a controllable airflow through the secondary pathway; wherein, when the casing houses the heat-exchange cartridge, (i) the primary ventilator forces an inflow of air in the building through the primary pathway, and (ii) the controllable second ventilator for controllably forcing an outflow from the building and an inflow of air in the building through the secondary pathway; and wherein, when the casing houses no heat-exchange cartridge, only an inflow of air in the building is forced through the ventilation apparatus.

According to an aspect, the ventilation apparatus comprises an inside face facing the inside of the building, and wherein the service door is mounted to the inside face, thereby providing access for servicing the ventilation apparatus from inside the building.

According to an embodiment, a method of operating the ventilation apparatus as described in at least one of the embodiments above in a poultry barn during a growth period of the poultry divided in an initial period and a following period, the method comprising: operating the ventilation apparatus with the heat-exchange cartridge housed by the ventilation apparatus during the initial period; and operating the ventilation apparatus without the heat-exchange cartridge being housed by the ventilation apparatus during the following period.

According to an aspect, the method further comprises operating the ventilation apparatus with the secondary ventilator forcing an inflow of air in the building during the initial period; and operating the ventilation apparatus with the secondary ventilator forcing an outflow of air during the following period; and/or with the initial period is divided in at least two sub-periods, operating the ventilation apparatus with the secondary ventilator not forcing an inflow or outflow of air during one of the sub-periods of the initial period; and/or with the initial period is divided in at least two sub-periods, operating the ventilation apparatus with the secondary ventilator forcing outflow of air during one of the sub-periods of the initial period; and/or with the ventilation apparatus further comprises a removable shutter for closing the secondary pathway, installing the removable shutter during the following period, thereby preventing back-drafts to be generated by the secondary pathway; and/or with the ventilation apparatus further comprises a removable spout for orienting inflow from the primary pathway, operating the ventilation apparatus with the spout mounted thereto during the initial period.

According to an aspect, the initial period lasts about: 3 weeks when ducks are yield in the poultry barn; 4 weeks when broilers and replacement pullets are yield in the poultry barn; and 6 to 8 weeks when turkeys are yield in the poultry barn. In some examples, the above ventilation apparatus may further comprise at least one detachable shutter operatively connected to the second ventilator so that there is no back-draft of air in said air conduit when said secondary ventilator is in tertiary mode, and/or a detachable spout mounted on the air conduit.

In some examples, the heat-exchanging cartridge may be made of a plurality of polypropylene sheets spaced by ethylene acetate strips, and/or said air conduit may be mounted on said service door, and/or an element forming a hollow rectangular shape may be mounted on the interior side of the service door providing a frame to secure at least one detachable shutter.

In some examples, the above ventilation apparatus may further comprise at least one interior shutter operatively connected to said primary air inlet to prevent back-draft of air entering in the casing from said primary air inlet. Said at least one interior shutter may be detachable.

In some examples, there may be a temperature sensor is monitoring air temperature in said air conduit, the secondary ventilator may have adjustable speed controlled by electronic means, e.g. a speed controller, as a function of said air temperature, the primary ventilator may have adjustable speed, the primary ventilator may also have a primary adjustable speed controlled by electronic means and said secondary ventilator has a secondary adjustable speed controlled by electronic means, the ventilation apparatus may further comprise a temperature sensor for monitoring air temperature in said air conduit, whereas said primary adjustable speed are controlled as a function of said air temperature, both said primary ventilator and said secondary ventilators may have different maximum rotational speeds, and/or said primary mode, secondary mode and tertiary mode may be selected automatically by electronic means.

In yet other examples, the heat-exchange cartridge may be mounted such that the primary pathway within the heat-exchange cartridge is substantially vertical, a.k.a. along a substantially vertical axis, said at least one walls of the casing may be thermally insulated, and/or said at least one air outlets and said at least one secondary air outlet/inlet may be equipped with wild bird-proof gratings, whereas said gratings may be selected from a group comprising metal grids, plastic grids and flexible screens. A set of nozzle sprinklers operatively connected to a water manifold may be disposed substantially on top of said heat-exchange cartridge, whereas the ventilation apparatus may further comprise a computer operatively connected to a solenoid valve, whereas said water manifold is controlled by said solenoid valve, which opens periodically in accordance to a sequence pre-programmed in said computer. Water may be collected and ejected through a drain opening at the bottom of said ventilation apparatus.

Also disclosed is the use of the above described examples of ventilation apparatus for poultry barns. In examples of such use said ventilation apparatus is used during the growth period of the poultry, such growth period being divided in an initial period and a following period; said ventilation apparatus is used with said heat-exchange cartridge being present in said casing and said secondary ventilator being set to its primary mode during said initial period, and said ventilation apparatus is used without said heat-exchange cartridge in said casing during said following period. Said secondary ventilator may be set in its secondary mode during said following period or said secondary ventilator may be set in its tertiary mode during a first portion of said following period and is set in its secondary mode during a second portion of said following period. Said initial period may be of 3 weeks for ducks, 4 weeks for broilers and replacement pullets, and 6 to 8 weeks for turkeys. Interior shutters may be secured to said frame only during said following period. A detachable spout may be mounted on the air conduit only during said initial period.

The disclosure further relates to the use of a ventilation apparatus for a poultry house in cold or temperate climates, whereas the ventilation apparatus unit has dual functionality: a primary function and to recover the exhausted heat from the ventilation of a poultry barn or other building in order to preheat the outside air that is drawn, through a heat-exchange cartridge, in the building to oxygenate the poultry flock or other livestock; and a secondary function, where the ventilation apparatus is equipped with an internal air inlet designed with shutters associated with a primary ventilator that discharges warm humid air into an insulated air conduct through said removable heat-exchange cartridge.

Such use of the ventilation apparatus may further include the use of a pressurized water sprinkler system to clean said heat-exchange cartridge. The warm humid air may be discharged through an external air outlet equipped with a metal grating. For such poultry house applications, the ventilation apparatus may be equipped with a secondary ventilator adapted for reversible rotation, so that upon reversal, said secondary ventilator draws cold fresh air through the heat-exchange cartridge from two external air inlets, each equipped with metal gratings. The cold fresh air from the two external air inlets recovers heat energy and then flows through a service door that may be designed to receive a set of removable shutters, and is finally discharged via an internal air outlet, which may be designed with a detachable spout, for best diffusion of the warm fresh air in the building.

In another alternative example of use of the ventilation apparatus for a poultry house, where the temperature differential from the external environment and the building diminishes to make heat recovery less desirable, or when the birds reach an age where dust levels are high and heating costs are low or inexistent, the ventilation apparatus may be switched for its secondary function, whereby both the primary ventilator and secondary ventilator are being used to exhaust air out of the building. More specifically, it can be switched by removing the heat-exchange cartridge, attaching the removable shutters in the appropriate support area of the service door, detaching the fresh air outlet spout and by inversing the secondary ventilator rotation.

In such alternative example of use of the ventilation apparatus for this secondary function, the primary ventilator and secondary ventilator may be used at variable speeds in order to achieve the desired air exhaust extraction. Alternatively, the secondary ventilator may be stopped completely, while only the first ventilator is used to exhaust air out of the building.

### BRIEF DESCRIPTION OF THE DRAWINGS

For a better understanding of the embodiments described herein and to show more clearly how they may be carried into effect, reference will now be made, by way of example only, to the accompanying drawings, which show at least one exemplary embodiment, and in which:

FIG. 1 shows a general perspective view of an embodiment of a ventilation apparatus in accordance with an exemplary embodiment;

FIG. 2 is a cross sectional view along a central vertical plane passing through the ventilation apparatus of FIG. 1, while the heat-exchange cartridge is installed thereinside;

FIG. 3 is a cross sectional view along the same plane as FIG. 2 of the ventilation apparatus in accordance with the same embodiment, but without the heat-exchange cartridge;

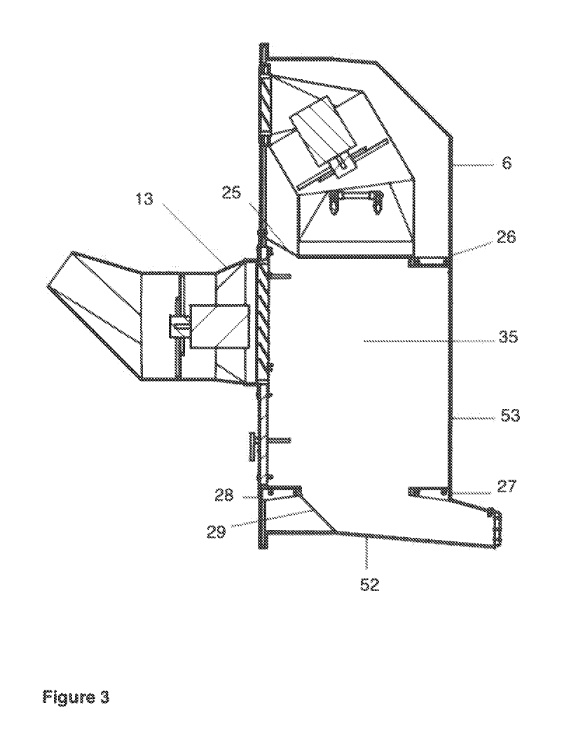

FIG. 4 is a cross sectional view along the same plane as FIGS. 2 and 3 with a perspective from the opposite side from the plane of the ventilation apparatus in accordance with the same embodiment, and without the heat-exchange cartridge, but with the service door opened, and equipped with shutters;

FIG. 5 is a side view along the same plane as FIGS. 2 to 4 from the same perspective as FIG. 4 of the ventilation apparatus in accordance with the same embodiment, with the service door opened and without shutters;

FIG. 6 is a front elevation view of the ventilation apparatus in accordance with the same embodiment, without the heat-exchange cartridge and with the service door opened;

FIG. 7 is an elevated perspective view showing a heat-exchange cartridge for use in the same embodiment;

FIG. 8 is an elevated perspective view showing a set of sprinklers for use in the same embodiment;

FIG. 9 is a cross sectional view similar to FIG. 2, showing the ventilation apparatus airflow in the heat recovery configuration, with the heat-exchange cartridge and without service door shutters, in accordance with the same embodiment;

FIG. 10 is a cross sectional view similar to FIG. 2, showing the ventilation apparatus airflow in the full exhaust configuration, without the heat-exchange cartridge and with the service doors equipped with shutters, in accordance with the same embodiment;

FIG. 11 is an elevated perspective view showing the inside of the ventilation apparatus casing, which illustrates the primary ventilator duct, the heat-exchange cartridge and the support plates;

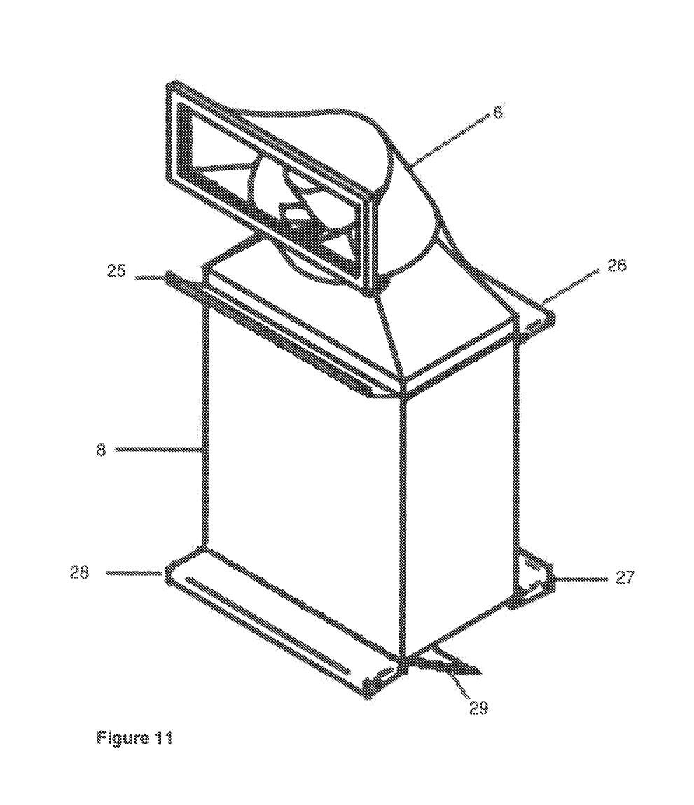

FIG. 12 is a chart illustrating the BTUs needed daily to grow 8000 broilers chickens in the province of Quebec (CANADA) during winter in function of the age of the flock in days; and

FIG. 13 is a chart showing an average and a linear trend of BTU consumption from six (6) different broiler houses in function of the age of the flock in days.

It will be noted that throughout the appended drawings, like features are identified by like reference numerals.

### DESCRIPTION OF VARIOUS EMBODIMENTS

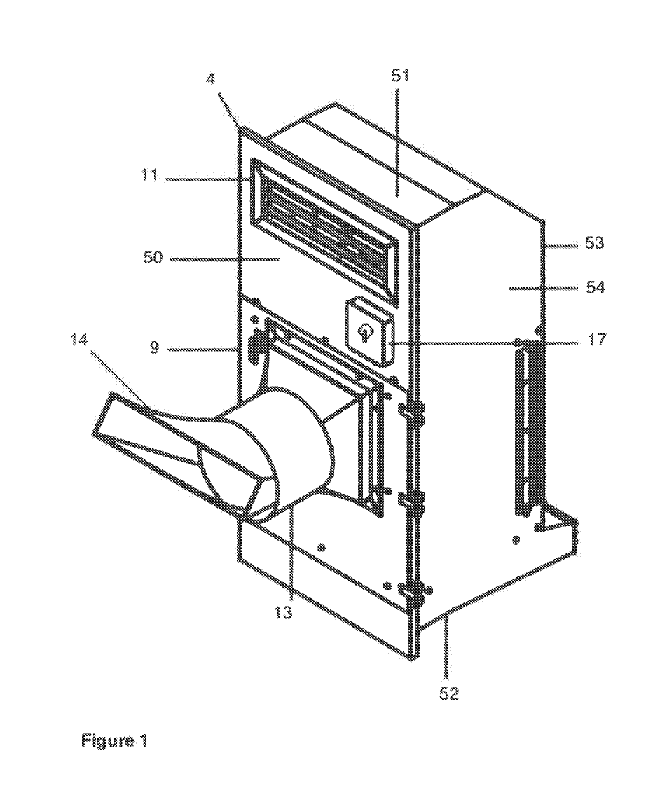

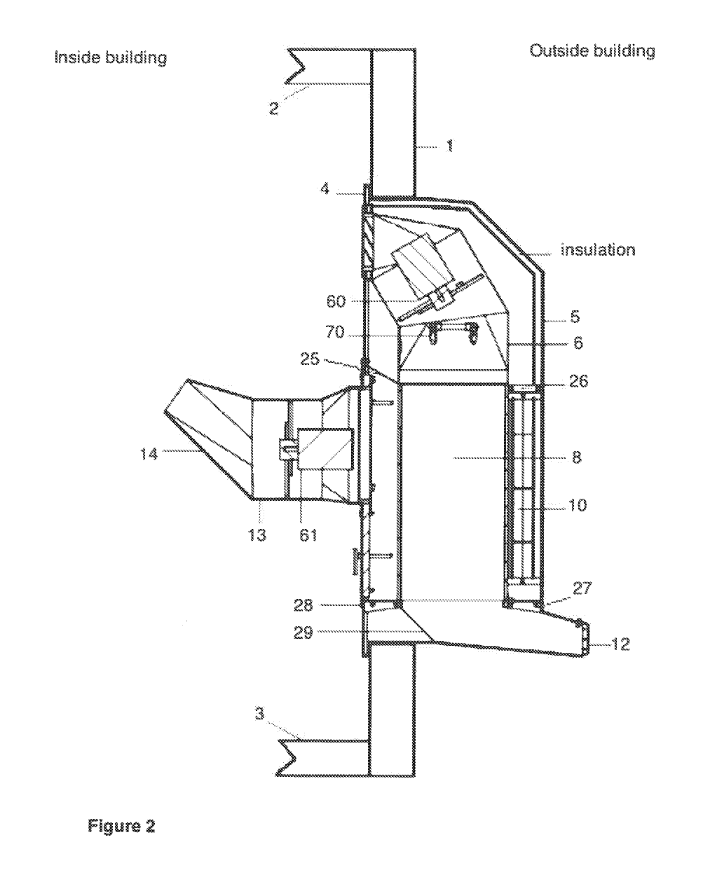

Referring now to the drawings, a first embodiment of the hybrid heat recovery system with energy recovery, a.k.a. ventilation apparatus, is shown for instance in FIGS. 1 and 2, wherein this embodiment of the ventilation apparatus includes a main body 5, a.k.a. a casing, comprising a plurality of walls, namely a front face 50, a top side 51, a bottom side 52, a rear wall portion 53 and a pair of parallel sidewalls 54. The ventilation apparatus includes a service door 9, which provides access to the interior of the casing, a primary air inlet 11, and an air conduit 13 having a removable spout 14 attached to its extremity.

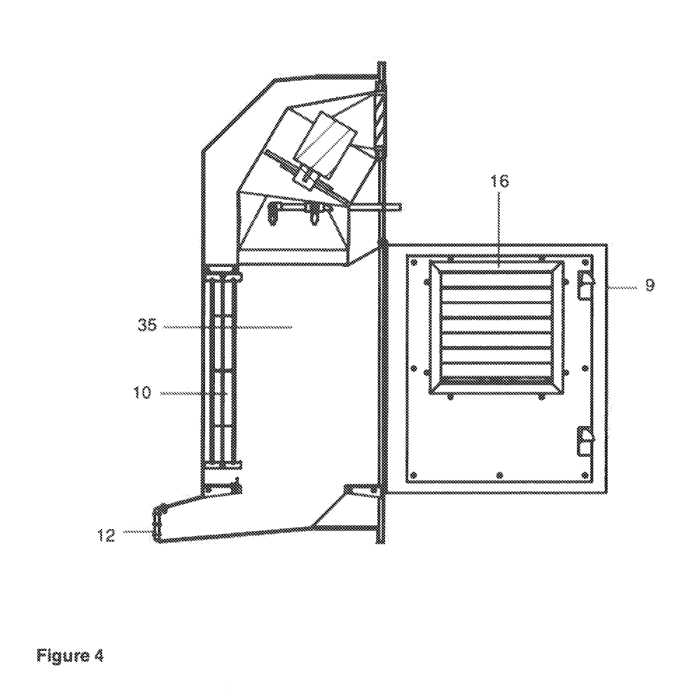

In FIG. 2, a cross sectional view along a central vertical plane passing through the ventilation apparatus of the same embodiment is shown as the ventilation apparatus may be installed through the exterior wall 1, a.k.a. a structural component or structure, of a building, further shown relatively to the ceiling 2 and the floor 3 of the building. The ventilation apparatus is installed in an opening passing through the wall 1 of the building is secured to the wall 1, wherein securing the ventilation apparatus may be performed by various conventional means, such as screws, bolts, rivets, fittings, fixtures, etc. The service door 9 (FIG. 4) and the removable spout 14 of the ventilation apparatus are situated within the building in the same area. Flange 4 and the outer portion of the front face 50 (FIG. 1) may perform a supporting function to have thereby the ventilation apparatus secured to the wall 1. Other means for supporting, the ventilation apparatus, in other words preventing the ventilation apparatus from tipping over the portion of the wall 1 supporting the ventilation apparatus, may be used, such as the use of stands or legs, as can be understood by a person skilled in the art.

In FIG. 2, the main body 5, the ventilator duct 6 and the air conduit 13 comprise three independent rotational moulded polyethylene pieces that are assembled into one whole unit. In this embodiment, the upper half, delimited by the rear side 53 (FIG. 1) and parallel sides 54 (FIG. 1) of the casing, the ventilator duct 6 and the stainless steel upper plates 25 and 26, is insulated with one (1) inch of polyurethane.

### The Heat Recovery Configuration

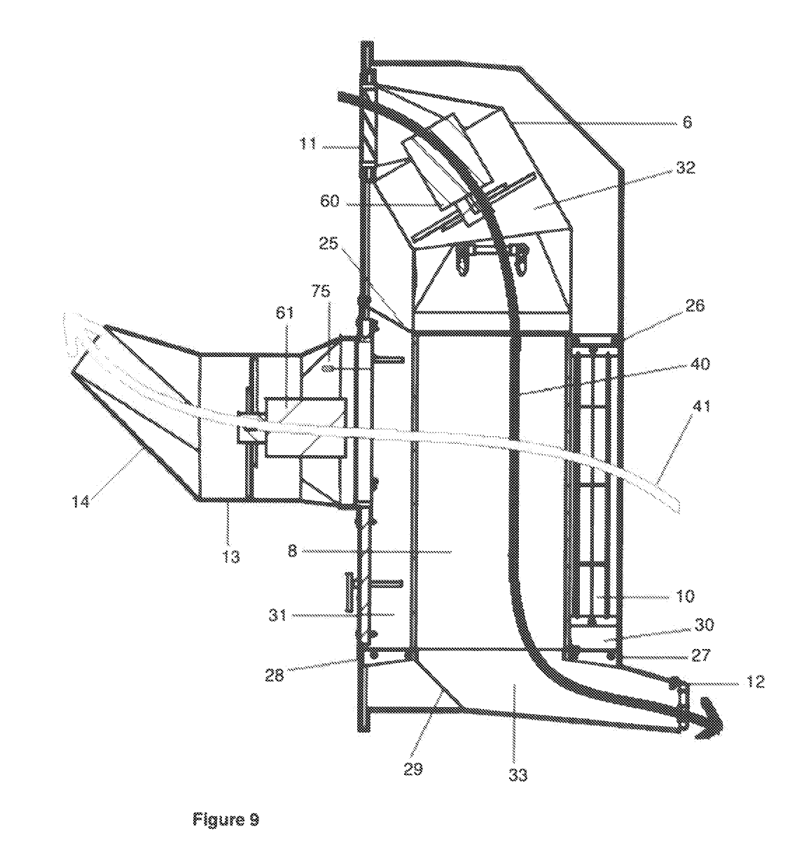

FIG. 9 shows the ventilation apparatus of FIG. 2 in a heat recovery configuration with airflows flowing in opposite directions with respect to an intake/outtake operation. A first airflow pathway with air flowing through the heat-exchange cartridge 8 from the air inlet 11 to the exterior of the building constitutes a primary pathway 40 fluidly connecting the inside to the outside of the building according to an intake operation. A second airflow pathway with air flowing through the heat-exchange cartridge 8 and out of the ventilation apparatus to the interior of the building constitutes a secondary pathway 41 according to an outtake operation.

One should understand that through the present disclosure inflow refers to a flow of air from the exterior of the building to the interior of the building, whereas outflow refers to a flow of air from the inside of the building to the outside of the building.

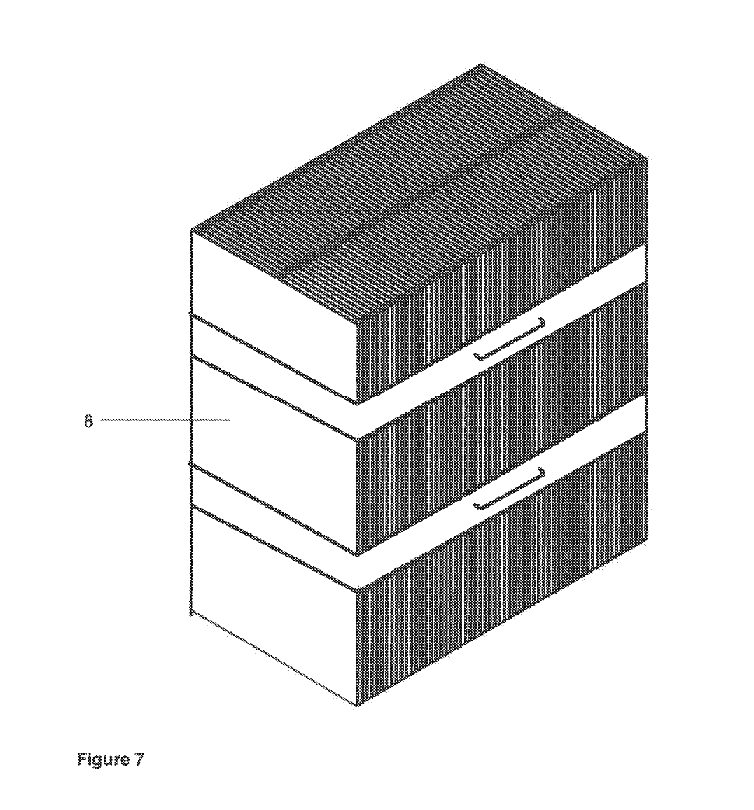

Returning to FIG. 2, a heat-exchange cartridge 8 is supported and housed within the enclosure (or casing) of the ventilation apparatus by means of stainless steel support plates 27 and 28 (FIG. 7 shows one example of such heat-exchange cartridge). The heat-exchange cartridge 8, together with the stainless steel support plates 27 and 28, a deflector plate 29 and the stainless steel upper plates 25 and 26 divide the enclosure and the heat-exchange cartridge 8 into an exterior air intake pathway (the primary pathway) 41 and an interior air outtake pathway (the secondary pathway) 40, as seen in FIG. 9, and described in more details hereinbelow. The two different pathways are segregated, including within the heat-exchange cartridge 8, and the air of one pathway is herein never in contact with the air of the other. Furthermore, according to an embodiment one pathway is along a substantially vertical axis while the other is along a substantially horizontal axis, having the axes substantially perpendicular to each other. Thus, the heat-exchange cartridge provides portions of the primary pathway 40 and secondary pathway 41 for within the cavity 35.

The heat-exchange cartridge 8 is oriented at a right angle with the front stainless steel support plate 28, such that the condensed water is flowing down by gravity at a right angle, which optimizes the speed of flow of the condensed water out of the heat-exchange cartridge 8 and thus helps prevent frosting.

According to an embodiment, the heat-exchange cartridge 8 comprises two handles (bracket-like portions located at the front of the heat-exchange cartridge on two intermediary belt portions of the heat-exchange cartridge) to facilitate its removal through the service door 9 for cleaning and disinfection of the air flutes and the air spaces between each polypropylene sheet of the heat-exchange cartridge 8. After cleaning, the heat-exchange cartridge 8 may be installed back in the casing for future usage.

According to an embodiment, the heat-exchange cartridge 8 comprises a plurality of polypropylene sheets spaced by ethylene acetate strips.

Referring back to FIG. 9, two exterior secondary air outlet/inlets 10 situated on each parallel side 54 of the enclosure (or casing 5) of the ventilation apparatus communicate with a rear area 30 (FIG. 9). The rear area 30 is defined as the area between the rear of the heat-exchange cartridge 8, the rear stainless steel support plate 27 and the rear stainless steel upper plate 26. This area communicates directly with the front side of the heat-exchange cartridge 8, to a front area 31. The front area 31 is defined as the area between the front of the heat-exchange cartridge 8, the front stainless steel support plate 28 and the front stainless steel upper plate 25 to the air conduit 13. The above structural features characterize the secondary pathway 41 of FIG. 9, which is completely isolated from the primary pathway 40.

In FIG. 2, each secondary air outlet/inlet 10 is equipped with a metal grating with bar spacing therebetween that is small enough to prevent the nesting of extrinsic wild birds in the ventilation apparatus. Now referring mainly to FIGS. 2 and 9, an inside air primary inlet 11 located on the upper front side of the casing communicates with an upper area 32. The upper area 32 is defined as the area between the ventilator duct 6 and the top of heat-exchange cartridge 8, this area communicates directly through the heat-exchange cartridge 8 to a lower area 33. The lower area 33 is defined as the area between the bottom of the heat-exchange cartridge 8, the stainless steel supporting plates 27 and 28, the deflector plate 29 and the primary air outlet 12. The above structural features characterize the primary pathway 40 of FIG. 9 which is herein completely isolated from the secondary pathway 41.

Again referring to FIG. 2, the primary air outlet 12 is equipped with metal grating with bar spacing therebetween that is small enough to prevent the nesting of extrinsic wild birds in the apparatus. As illustrated in FIG. 1, the front face 50 of the main body 5 comprises the primary air inlet 11 accompanied with assorted shutters and a service hinged stainless steel service door 9 with a frame opening to receive another set of shutters on the interior side of the door, these shutters being used when the ventilation apparatus is converted to the dual exhaust ventilation configuration, as described below.

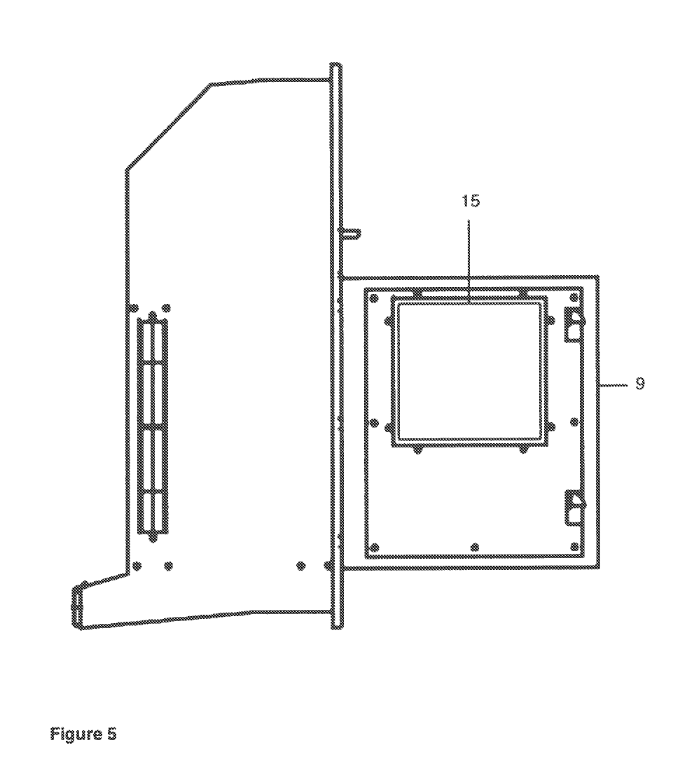

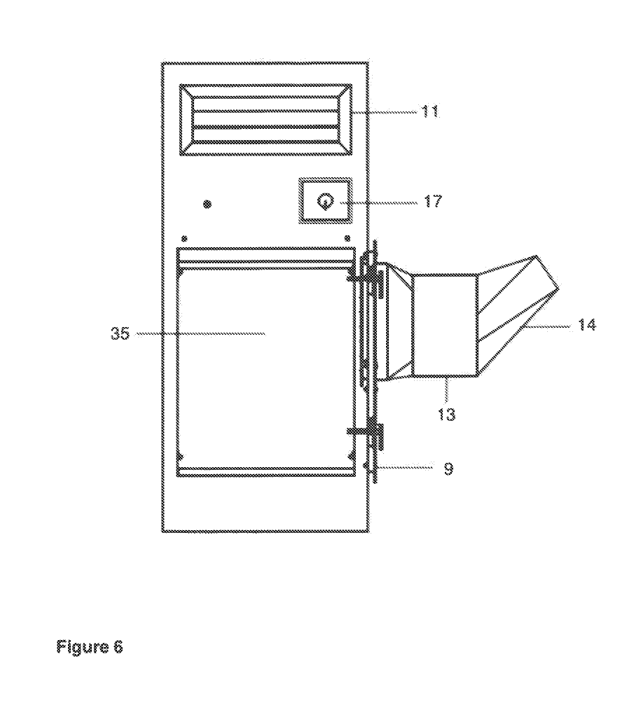

FIGS. 5 and 6 illustrate the situation whereby the service door 9 is in the open position thereby providing access to the interior 35 of the ventilation apparatus and thus the heat-exchange cartridge 8, when present. This provides access to the interior 35 also to convert to the ventilation apparatus to the dual exhaust ventilation configuration. When the service door 9 is open, an operator may remove the heat-exchange cartridge 8 manually.

Referring additionally to FIG. 9, the exterior side of the service door 9 also includes an air conduit 13 on which the secondary ventilator 61 is mounted. The secondary ventilator 61 is, in this embodiment, a variable speed ventilator. The secondary ventilator 61 pulls cold fresh air from both secondary air outlet/inlets 10 (operating as inlets in this configuration) and expels the air in the secondary pathway 41, thus through the heat-exchange cartridge 8 in the air conduit 13. This air conduit 13 is equipped with a removable spout 14 that extends inside the building. Through the removable spout 14, the air is finally discharged in the building, as shown as the secondary pathway 41 in FIG. 9. The removable spout 14 is meant to diffuse efficiently the air into the building as the secondary ventilator 61 expels it.

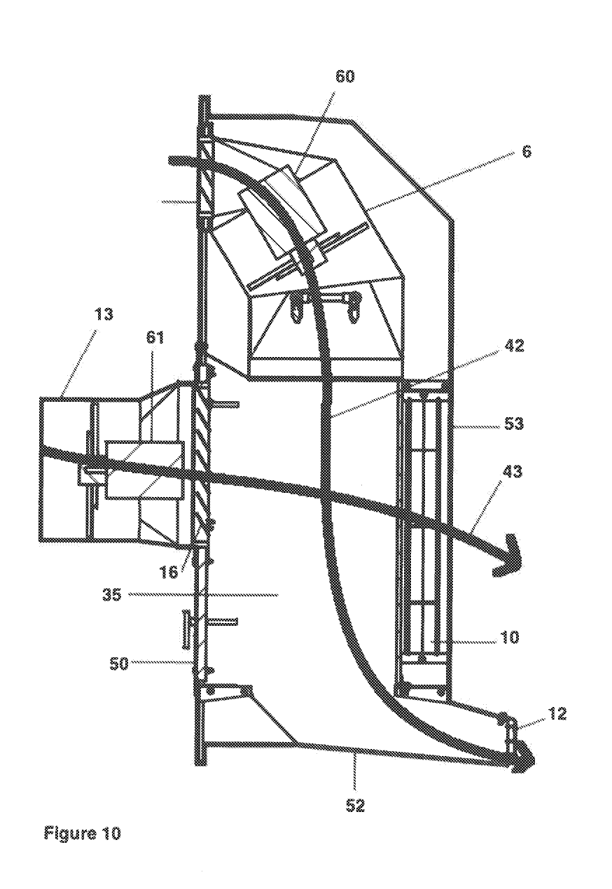

The ventilator duct 6 comprises a primary ventilator 60 (FIG. 10). In this embodiment, the primary ventilator 60 is a variable speed ventilator, pulling warm humid air though the primary air inlet 11 along the primary pathway 40. The primary ventilator 60 pushes the air downwardly through the heat-exchange cartridge 8 into the lower area 33 and finally out of the ventilation apparatus through the primary air outlet 12, as shown in FIG. 9.

As shown in FIG. 9, a temperature sensor 75 is located in the air conduit 13, within the secondary pathway 41. This temperature sensor 75 monitors the temperature of the cold fresh air discharged through the spout 14 into the building. The function of the temperature sensor 75 is to provide a signal to an electrical variable relay, resulting in the secondary ventilator 61 adjusting (e.g. decreasing) its rotational speed in order to adjust (e.g. decrease) the airflow rate through the secondary pathway 41, and thus adjust (e.g. increase) the temperature in the secondary pathway 41. This flow control helps to prevent the heat-exchange cartridge 8 from freezing and also allows for a better control of the air temperature discharged inside the building housing very young poultry flock in times of very cold weather. This feature ensures a more uniform temperature within the building even when exterior temperatures are several degrees below freezing.

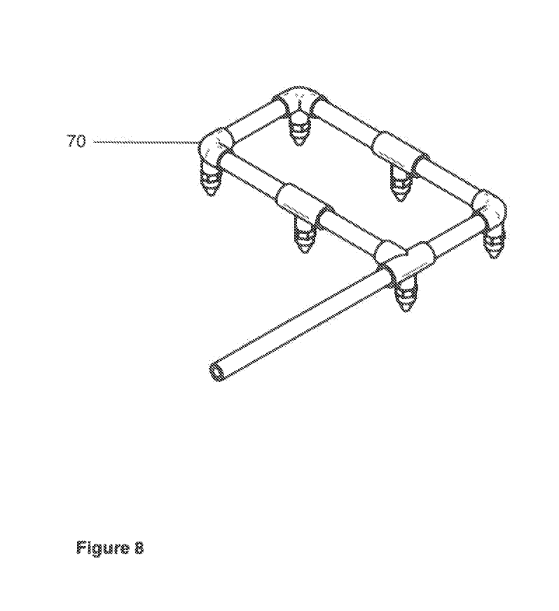

In the present embodiment, the ventilation apparatus also comprises a means to clean the heat-exchange cartridge 8 as fouling occurs when the ventilation apparatus is operated in the heat recovery configuration late in the growing cycle of the flock. An array of sprinkler nozzles 70 (FIGS. 2 and 8) are installed under the primary ventilator 60 in the ventilator duct 6 of the primary pathway 40. These sprinkler nozzles 70 are connected to a water line (not shown) and a solenoid valve (not shown) that is activated by electronic means, such as a timer relay within the ventilation control computer of the building. Such computer may be integrated or separate from the ventilation apparatus and may be dedicated to control the ventilation apparatus, or may control several ventilation apparatuses as well as possibly other ventilation components of the building.

The computer is programmed to increase the cleaning sequence according to a flock growth curve and the type of poultry species raised in the building. As the flock ages, the computer will adapt its cleaning sequences (frequency, duration, other characteristics). The duration of cleaning, which may be adapted by the grower using the ventilation control computer, is also controlled according to a programmable growth curve, and thus varies in function of the age of the birds. Cleaning is typically programmed at night, when water consumption associated with other operations is at its lowest. A detailed illustration of the nozzle assembly comprising the sprinkle nozzles 70 is shown in FIG. 8. The illustrated configuration shows six sprinkler nozzles 70 pointing downward in parallel to have the sprinkles water covering substantially the entire top surface of the heat-exchange cartridge 8. According to an embodiment, a drain opening is located at the bottom of the casing to ensure waste water collection. The bottom floor 52 of the ventilation apparatus, according to an embodiment, is oriented in a way for the wastewater to naturally flow via a drain such as to be recuperated at the desired location.

### The Dual Exhaust Configuration

Referring now to FIG. 10 and to the description of the ventilation apparatus in the dual exhaust ventilation system, with airflows in a same direction with respect to an intake/outtake operation. The ventilation apparatus includes a means to remove the heat-exchange cartridge 8 to create a large cavity 35. The large cavity 35 is defined as the area between the ventilator duct 6, the bottom side 52, the rear wall portion 53, the front face 50, including the air conduit 13, and the parallel sidewalls 54.

The ventilation apparatus, as shown in FIG. 5, is equipped with the aforementioned stainless steel service door 9 designed with a square-shaped hole (not visible) surrounded by a square frame 15 located on the opposite side of the service door 9 where the air conduit 13 attaches to the service door 9. The square frame 15 is designed to receive a removable square-shaped air shutter assembly hereafter described as the secondary removable shutters 16 (FIG. 4). These shutters are installed and secured on the service door 9 with mounting components when the heat recovery heat-exchange cartridge 8 is removed, when heat-exchange is no longer significant, for example when outside temperatures rise in the summer. FIGS. 5 and 6 show the service door 9 in the open position, adapted for removal of the heat-exchange cartridge 8 from the ventilation apparatus.

According to an embodiment, the heat-exchanging cartridge 8 may be made of a plurality of polypropylene sheets spaced by ethylene acetate strips, and/or the air conduit may be mounted on the service door 9, and/or mounting components forming, according to an embodiment, a hollow rectangular shape may be mounted on the interior side of the service door 9 to provide a frame to secure at least one detachable shutter 16. According to an embodiment, the heat-exchange cartridge 8 is serviceable, namely installable and removable, through an opening in the ventilation apparatus, which is selectively substantially closed by the service door 9.

This ventilation apparatus presents a means to reverse the rotation of the secondary ventilator 61. Various electrical and mechanical means for controlling the direction of rotation can be used, as can be understood by a person skilled in the art. In this example, a relay switch box 17 (FIG. 1) is located on the front face 50 of the main body 5, where a command double pole double throw switch can be operated to reverse the rotation of the secondary ventilator 61. This switch is manually activated to first stop the secondary ventilator 61 that slows down as not powered, and then secondly to reverse the rotation of the secondary ventilator 61. Once the rotation has been reversed, both ventilators (60 and 61) will draw and discharge air in the same direction.

In such dual exhaust configuration, air flows generally from the primary ventilator 60 to the primary air outlet 12, and according to the tertiary pathway 42 (inverse of secondary pathway 41 of FIG. 9), as illustrated in FIG. 10. This air exhaust is complemented by another air flow which generally follows the pathway from the secondary ventilator 61 to the secondary air outlet/inlets 10 (which functions as inlets under the heat recovery configuration but as outlets under this dual exhaust configuration), namely the quaternary pathway 43 in FIG. 10 (identical to the secondary pathway 40 of FIG. 9). As can be seen in FIG. 10, there is no heat-exchange cartridge 8 installed in the casing of the ventilation apparatus when in the dual exhaust ventilation configuration. Therefore, the tertiary and quaternary pathways 42 and 43 will cross in the cavity 35, providing opportunity for significant mix of these general air flow pathways 42 and 43 within the cavity 35. In this example according to this embodiment, warm humid air is drawn both (i) through the air conduit 13, where the secondary ventilator 61 draws the air, through the secondary shutters 16 and to the cavity 35, and (ii) through shutters 16, then through the ventilator duct 6 to the cavity 35. Air is then exhausted from the cavity by both the primary air outlet 12 and/or the secondary air outlet/inlets 10 (operating as outlets in this configuration).

The ventilation apparatus is designed with the aforementioned removable spout 14 that may be removed when flow generated by the secondary ventilator 61 is reversed to result in a more compact apparatus and also to reduce any unnecessary air friction. A circular metal grating is permanently installed in the air conduit 13 in front of the secondary ventilator impeller for security reasons. The spout 14 may be reinstalled when the unit is converted back to the heat recovery configuration.

The primary ventilator 60 has a variable rotational speed that is controlled independent from the secondary ventilator 61. In an embodiment, each one of the ventilators 60 and 61 is activated by an independent electrical variable relay controlled by a computer (not shown) in function of the required building level of ventilation. Furthermore, in some embodiments, one or both of the ventilators 60 and 61 may be variable speed ventilators.

When the ventilation apparatus is in its double exhaust configuration, without a heat-exchange cartridge 8 installed in the casing, the ventilation apparatus may be designed and controlled by electronic means to respond to various ventilation needs of the building. For example, a first level of ventilation may be satisfied with the primary ventilator 60, a second level of ventilation may be satisfied in addition with the secondary ventilator 61, and subsequent levels of ventilation may be satisfied with the remaining traditional ventilators of the building. Therefore, on occasions when only the primary ventilator 60 is in demand, and the secondary ventilator 61 is stopped, the removable air shutters 16 in the service door 9 prevent any undesired back-drafts inside the building.

### Other Characteristics of Some Examples

Such an above-described ventilation apparatus may be used, for example, in commercial poultry houses. Such a ventilation apparatus may recover heat energy from the exhaust ventilation only when it is most economically profitable to do so for the grower. The ventilation apparatus may be converted to a full exhaust ventilation system when dust levels rise and heating costs diminish as the flock matures to market weight.

The ventilation apparatus, according to an embodiment, includes the service door 9 to access, remove and/or replace the heat-exchange cartridge 8, and to install a set of shutters for preventing back-drafts. A simple electrical relay mechanism can be used to reverse the secondary ventilator rotation, which will result in an apparatus that functions as a dual exhaust ventilation system. In the latter configuration, the ventilation apparatus is no longer meant to recover heat energy but rather designed to increase the ventilation output of the commercial poultry barn or other building. These shutters ensure that no air back-drafts or unwanted air current enters into the building through the ventilation apparatus whenever the secondary ventilator 61 is not in function. The dual exhaust ventilation configuration may be used as the flock ages and the ambient air becomes filled with dust and down while it is no longer necessary to maintain high brooding temperatures. The dual exhaust ventilation system configuration may also be used in the warmer seasons where additional ventilation output is desirable to maintain the temperature within the building.

The ventilation apparatus may be integrated in the design of a building by contractors and builders, when designing the construction of a new poultry barn or other building, to serve to provide both warm season minimum ventilation as well as cold season heat recovery functions. Therefore, in investing in the ventilation apparatus, with its hybrid heat-exchange function, requirements for traditional fans providing summer minimum ventilation may be obsolete. Thus, the ventilation apparatus may reduce the overall building costs.

In addition, for poultry applications, since less dust is generated at the brooding time and since such dust can be removed by the programmed water cleaning sequence, the apparatus may operate without filters during the brooding time. In general, filters restrict airflow and eventually increase the workload of the ventilator, which may be avoided in the ventilation apparatus when configured without filters. Filters also reduce the airflow rate of a ventilator and thus reduce its performance, which may also be avoided when the filters are removed.

The following table shows an example of the washing sequence that could be programmed by the farm manager in the ventilation computer in relation to the age of the flock for filter-less applications, according to an embodiment. More specifically, it shows an example as used in a humid continental climate (Dfb in the Köppen climate classification) for chickens. During the first days of growth, the air is free of dust and down in, whereby cleaning time requirements are short and happen only once in the first four (4) days of growth. As the chickens age, cleaning requirements are longer cleaning time and more frequent cleanings. If a grower wishes to recover energy until the very end of the chicken life, it is possible to clean twice daily if necessary. As can be understood by a person skilled in the art, the washing sequence may vary as a function of various parameters, including the climate around the building, the type of poultry, the air debit and the building configuration and size.

| Days | Washing time | | Washing sequence |
|---|---|---|---|
| 1 to 4 | 30 | secs | Every 4 days |
| 5 to 10 | 40 | secs | Every 3 days |
| 11 to 14 | 50 | secs | Every 2 days |
| 15 to 18 | 60 | secs | Every day |
| 18 to 21 | 70 | secs | Every day |
| 22 to 25 | 80 | secs | Every day |
| 25 and on | 90 | secs | Every day |

As described above, including with respect to FIGS. 9 and 10, the ventilation apparatus comprises the aforementioned primary air inlet 11 associated with the primary ventilator 60 and the primary air outlet 12; and at least one secondary air outlet/inlet 10 associated with the secondary ventilator 61 and the air conduit 13. The ventilation apparatus may be installed in an opening in an exterior wall of a building so that the primary air outlet and secondary air outlet/inlets are communicating with the exterior. The primary air inlet and the air conduit, as well as the heat-exchange cartridge 8 and the service door 9 would then connect to/be accessible from the interior of the building.

According to an embodiment, the ventilation apparatus has the aforementioned detachable spout 14 attached to the air conduit 13, as shown in FIG. 1, preferably easily detachable by an operator within the building, adapted to provide a more compact apparatus footprint within the building, thereby facilitating the circulation of small tractors along the apparatus during the in-barn manure removal at the end of each poultry production cycle.

According to an embodiment, the ventilation apparatus may comprise an insulated layer on portions of the main body 5, as shown in FIG. 2. The insulated layer prevents water from condensing inside the ventilation apparatus. Such insulation layer within the casing also helps in improving the overall heat recovery efficiency of the ventilation apparatus.

According to an embodiment, the ventilation apparatus uses the heat-exchange cartridge 8 comprising two separate air paths mutually at right angles. According to a preferred embodiment, in the ventilation apparatus the heat-exchange cartridge 8 is preferably be oriented vertically, so that the warm humid air travels downward, and the condensate water flows downward. In one embodiment, the orientation may be substantially normal (90 degrees) to the ground level, so that the condensed water may flow at the same normal angle. This orientation of the heat-exchange cartridge 8 assures a rapid drainage of the condensed water and helps to prevent frosting within the heat-exchange cartridge 8 during cold weather seasons or in other such situations when the air temperature is close to or below the freezing temperature of water.

In some embodiments, control elements (sensors, clearance detectors, etc.) are integrated in the design of the ventilation apparatus for the secondary ventilator 61 to be possible to be inverted only when the heat-exchange cartridge 8 is removed from the ventilation apparatus. Such a solution prevents the secondary ventilator 61 from blowing warm foul air within the fresh air flutes, which would in turn contaminate the heat-exchange cartridge 8.

According to an embodiment, the ventilation apparatus described herein comprise grating, grids or screens integrated, attached, or clipped on the air outlet/inlets and outlets facing the exterior of the building. Such grating, grids or screens may be made of metal, plastic and any other such material strong enough to withstand the air pressure and suitable to prevent wild migratory or domestic birds from nesting in the openings of the air outlet/inlets and air outlets accessible from the exterior of the building. The grating, grids or screens in turn help to reduce the risks of outbreak of avian contagious diseases and proliferation induced by foreign migrating birds living around commercial poultry houses.

According to an embodiment, the primary ventilator 60 has a maximum rotation speed twice as fast as the secondary ventilator 61 to allow more warm air moving in the primary pathway 40 than cold fresh air flowing in the secondary pathway 41 to help prevent frosting of the heat-exchange cartridge 8 in cold climates. In addition, this feature may provide warmer incoming air in very cold weeks of winter, as opposed to zero static pressure systems where both opposed airflow rates are identical and the fresh air temperature intake is not adjustable.

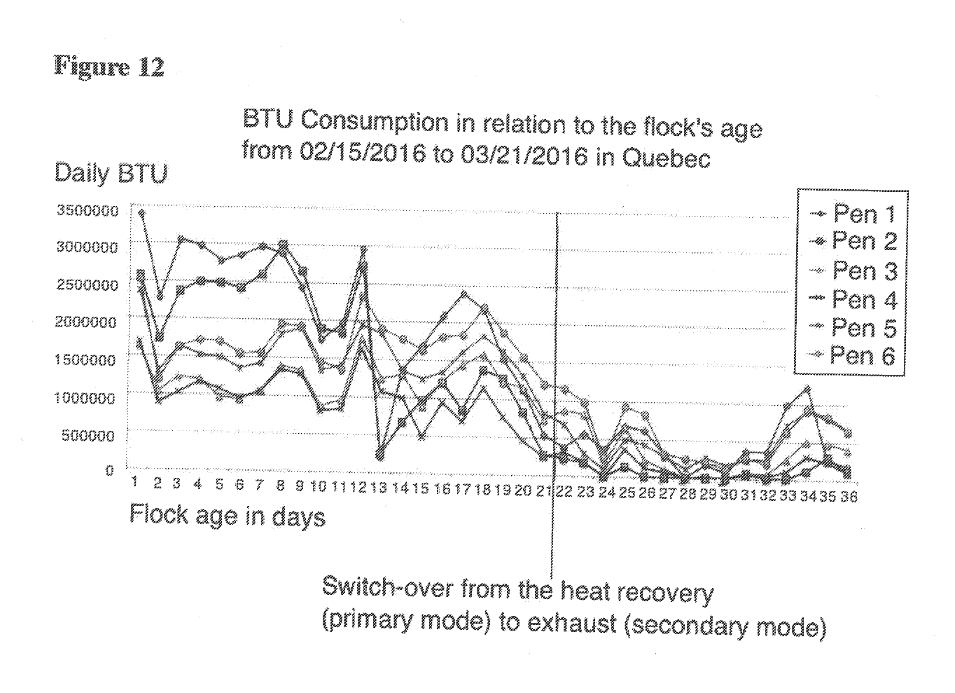

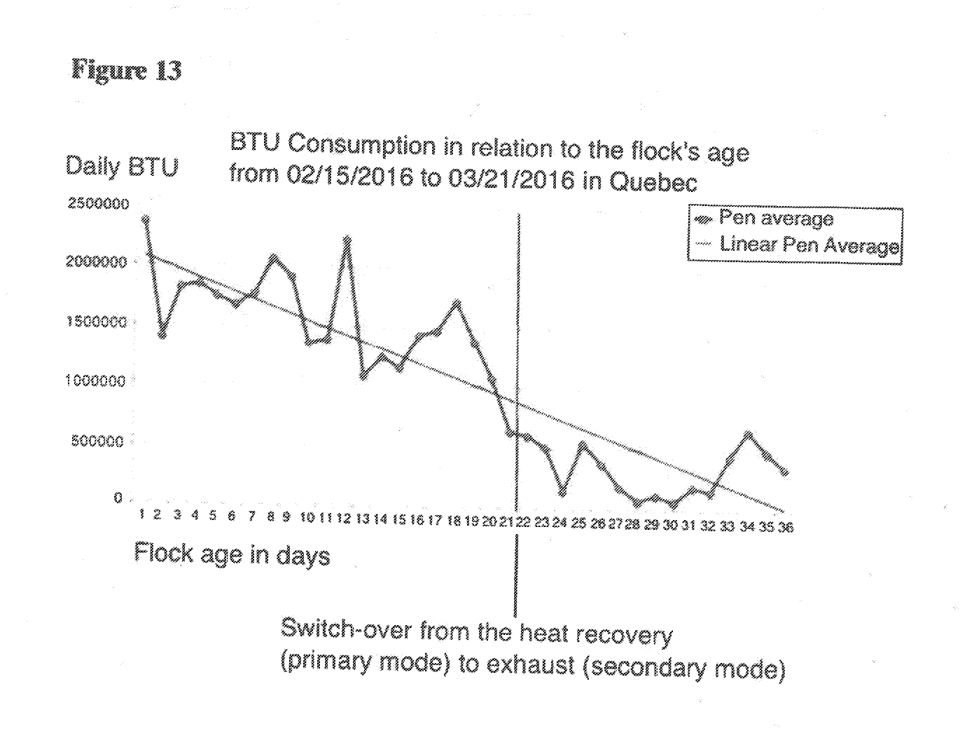

According to an embodiment, the ventilation apparatus recuperates heat energy by a heat-exchange process only in the first weeks of the brooding period, since, as dust is minimal, fouling is also minimal. For example, from a test, FIG. 12 compares the BTUs needed to heat six (6) different broiler pens each containing eight thousand (8000) chickens from day one (1) to day thirty-six (36) within the same dates of winter 2016 in Granby, in the Province of Quebec, Canada (being a humid continental climate, Dfb in the Köppen climate classification). All chicks were placed in six (6) different houses, and were ready for the market forty-eight (48) days later. The source of heat was natural gas. As one may observe, in all pens from this farm, the heating cost is most significant in the three first weeks of growth. FIG. 13 illustrates average heat consumption from the latter six (6) pens. From the average curve shown on FIG. 13, it may be observed that the heating cost during in the first three weeks is about three times (3×) the heating cost during the remaining two weeks of growth. In this particular case (FIGS. 12 and 13), it would have been of interest to recover energy with the ventilation apparatus in the primary mode from day one (1) to day twenty-one (21) and then to convert the ventilation apparatus (switch-over) to its secondary mode to use both ventilators 60 and 61 to exhaust air from the building. Thus, fouling of the cartridge is limited to the first three weeks of growth, when the building is kept relatively clean and when most of the heating is required. As would be understood by a person skilled in the art, the ideal moment for the conversion (switch-over) of the ventilation apparatus may vary as a function of various parameters, including the climate, the type of poultry, configuration and size of the building. Furthermore, each poultry grower could decide the optimal moment for conversion (switching over) the ventilation apparatus as a function of other commercial constraints, such as staff availability.

According to an embodiment, at least one air outlet and the at least one secondary air outlet/inlet may be equipped with wild bird-proof gratings, whereas such gratings may be selected from a group comprising metal grids, plastic grids and flexible screens.

As would be understood by a person skilled in the art, such ventilation apparatus may also be used for industrial applications, such as in factories producing large amounts of dust (e.g. metallic particles, plastic particles, wood particles, other organic particles), which may clog some other heat-exchangers. The above described ventilation apparatus may also be used in other agricultural activities, such as other livestock farming, and especially in situations where dust is generated by the livestock and where heat recovery is of concern only during some periods of the year.

Also, such ventilation apparatus may also be integrated in the building construction in various ways. The above examples thereby serve only for illustrative purposes. For example, several such ventilation apparatuses may be stacked or installed at various heights, for example in multi-story poultry houses where such ventilation systems could be installed and serviced from the inside of the building at each level of this building. This configuration avoids the need for ladders, steps, ramps or other security equipment that may be needed when service has to be performed from outside the building.

While the above description provides examples of the embodiments, it will be appreciated that some features and/or functions of the described embodiments are susceptible to modification without departing from the spirit and principles of operation of the described embodiments. Accordingly, what has been described above has been intended to be illustrative of the embodiments and non-limiting, and it will be understood by persons skilled in the art that other variants and modifications may be made without departing from the scope of the embodiments as defined in the claims appended hereto.

1. A ventilation apparatus to be mounted to a structure of a building to provide ventilation to the building, the ventilation apparatus comprising:
a casing comprising:
a cavity adapted to house a removable heat-exchange cartridge;
a service door providing access to the cavity;
a primary air inlet fluidly connecting the cavity to the interior of the building;
a primary air outlet fluidly connecting the cavity to the exterior of building, wherein a primary pathway fluidly connects the primary air inlet to the primary air outlet;
a secondary air outlet/inlet, distinct from the primary air outlet, fluidly connecting the cavity to the exterior of the building,
an air conduit, distinct from the primary air inlet, fluidly connecting the cavity to the interior of the building, wherein a secondary pathway fluidly connects the secondary air inlet/outlet to the air conduit;
a primary ventilator for forcing an airflow through the primary pathway; and
a secondary ventilator for forcing an airflow through the secondary pathway;
wherein, when the casing houses the heat-exchange cartridge,
(i) the primary ventilator forces an inflow of air in the building through the primary pathway, and
(ii) the second ventilator when operating in a primary mode forces an outflow of air from the building through the secondary pathway, and when operating in a secondary mode forces inflow of air in the building through the secondary pathway; and
wherein, when the casing houses no heat-exchange cartridge, only an inflow of air in the building is forced through the ventilation apparatus.

2. The ventilation apparatus of claim 1, wherein the heat-exchange cartridge comprises a plurality of polypropylene sheets spaced by ethylene acetate strips.

3. The ventilation apparatus of claim 1, wherein the primary pathway passes through the heat-exchange cartridge about a substantially vertical axis.

4. The ventilation apparatus of claim 1, wherein the primary pathway and the secondary pathway pass through the heat-exchange cartridge about substantially perpendicular axes.

5. The ventilation apparatus of claim 4, wherein the heat-exchange cartridge provides segregated airflows of the primary pathway and of the secondary pathway.

6. The ventilation apparatus of any claim 1, wherein the second ventilator is a rotational ventilator can operate in a first rotational direction thereby generating the outflow and can operate a second rotational direction thereby generating the inflow.

7. The ventilation apparatus of claim 1, wherein the primary ventilator has a primary maximum rotation speed and the secondary ventilator as a second maximum rotation speed, and wherein the primary maximum rotation speed is different from the secondary maximum rotation speed.

8. The ventilation apparatus of claim 7, wherein ventilation apparatus has a rotation speed ratio defined by the primary maximum rotation speed over the secondary maximum rotation speed of about 2 or above.

9. The ventilation apparatus of claim 1, further comprising shutters operatively connected to the secondary pathway, wherein the shutters are for closing the secondary pathway and thereby preventing back-drafts.

10. The ventilation apparatus of claim 9, wherein the shutters are removably mounted to one of the secondary air inlet/outlet and the air conduit.

11. The ventilation apparatus of claim 9, wherein the shutter is operatively connected to the secondary pathway for preventing back-drafts.

12. The ventilation apparatus of claim 1, wherein the air conduit is mounted to the service door.

13. The ventilation apparatus of claim 1, wherein the service door comprises mounting components on its interior side, and wherein the mounting components are used to secure a detachable shutter to the service door.

14. The ventilation apparatus of claim 1, further comprising a temperature sensor fluidly monitoring temperature of airflow in the primary pathway.

15. The ventilation apparatus of claim 14, wherein the temperature sensor in mounted to the air conduit.

16. The ventilation apparatus of claim 14, wherein the speed controller establishes a rotation speed for the operatively connected one of the primary ventilator and the secondary ventilator based on temperature monitored by the temperature sensor.

17. The ventilation apparatus of claim 1, further comprising a sprinkler nozzle fluidly connected to a water manifold, wherein the sprinkler nozzle is located substantially over the heat-exchange cartridge.

18. The ventilation apparatus of claim 17, further comprising a drain located below the casing, wherein the drain is for draining water sprayed by the sprinkler nozzle.

19. A ventilation apparatus to be mounted to a structure of a building to provide ventilation to the building, the ventilation apparatus comprising:
a casing comprising:
a cavity adapted to house a removable heat-exchange cartridge;
a service door providing access to the cavity;
a primary pathway fluidly connecting the inside of the building to the outside of the building;
a secondary pathway fluidly connecting the inside of the building to the outside of the building, wherein the primary pathway and the secondary pathway cross the cavity along about perpendicular axes;
a primary ventilator for forcing an airflow of air in the building through the primary pathway; and
a controllable secondary ventilator for forcing a controllable airflow through the secondary pathway;
wherein, when the casing houses the heat-exchange cartridge,
(i) the primary ventilator forces an inflow of air in the building through the primary pathway, and
(ii) the controllable second ventilator for controllably forcing an outflow from the building and an inflow of air in the building through the secondary pathway; and
wherein, when the casing houses no heat-exchange cartridge, only an inflow of air in the building is forced through the ventilation apparatus.

20. The ventilation apparatus of claim 19, comprising an inside face facing the inside of the building, and wherein the service door is mounted to the inside face, thereby providing access for servicing the ventilation apparatus from inside the building.
